(19) United States
(12) Patent Application Publication
(10) Pub. No.: US 2006/0158731 A1
(43) Pub. Date: Jul. 20, 2006

(54) FOCUS fixation

(75) Inventor: Jesse B. Eichenlaub, Penfield, NY (US)

Correspondence Address: Stephen B. Salai, Esq.;Harter, Secrest & Emery LLP, 1600 Bausch & Lomb Place, Rochester, NY, 14604-2711, US

(73) Assignee: Dimension Technologies, Inc., Rochester, NY (US)

(21) Appl. No.: 11/037,638

(22) Filed: Jan. 18, 2005

(51) Int. Cl. G02B 27/22

(52) U.S. Cl. 359/462; 359/466

(57) ABSTRACT

A method and apparatus for reducing the effects of FOCUS fixation includes a multiple perspective autostereoscopic display, a controller for receiving image inputs from a source and connected to the autostereoscopic display, and together with the multiple perspective autostereoscopic display, forming a plurality of viewing zones associated with different perspectives, each of the viewing zones being smaller than the pupil of a user, and at least two of the viewing zones being coincident with a pupil of an eye of an observer without the pupil moving.

### BACKGROUND OF THE INVENTION

This invention relates to a method and apparatus for reducing the effects of FOCUS fixation.

### BRIEF SUMMARY OF THE INVENTION

Briefly stated and in accordance with one aspect of the invention, a method and apparatus for reducing the effects of FOCUS fixation includes a multiple perspective autostereoscopic display, a controller for receiving image inputs from a source and connected to the autostereoscopic display and together with the multiple perspective autostereoscopic display, forming a plurality of viewing zones associated with different perspectives, each of the viewing zones being smaller than the pupil of a user, and at least two of the viewing zones being coincident with a pupil of an eye of an observer without the pupil moving.

### BRIEF DESCRIPTION OF THE SEVERAL VIEWS OF THE DRAWINGS

FIG. 1 is a diagrammatic view of a static head mounted display.

FIG. 2 is a diagrammatic view of a display system without FOCUS/fixation disparity.

FIG. 3 is a diagrammatic view of apparatus for creating divergent ray bundles.

FIG. 4 is a diagrammatic view of a one-dimensional array of rectangular viewing zones.

FIG. 5 is a diagrammatic view of the display showing the geometry of astigmatism.

FIG. 6 is a diagrammatic view of a double row of rectangular viewing zones.

### DETAILED DESCRIPTION OF THE INVENTION

There are many applications where the disparity between focus and fixation points in head mounted stereoscopic viewing systems creates a problem for the viewer in terms of eyestrain, defocused images, or inability to fuse images. Such problems show up during two types of viewing conditions: one in which objects must be represented across a wide range of distances from the user, from very close to very far away (example: vehicle simulation, especially ground vehicles), and one in which the system is used to superimpose virtual objects or information, on a relatively close real world scene (example, a maintenance training device that is designed to illustrate correct placement of parts by superimposing their virtual images on the real scene). In the former case, the distance at which the eye focuses to see images on the display is set at some distance, usually between six feet and infinity, and eyestrain may occur or double images may be perceived if the viewer tries to converge his eyes to fuse parts of the stereoscopic image that are much closer or farther away than that distance. In the latter case, the display is also imaged at a certain distance, and if objects are represented as being even a very short distance off the screen image, there will be a mismatch between the focus required to see the virtual objects and the focus required to see the real world area on which it is superimposed. The result is that one or the other will always be blurred.

The discomfort, eyestrain, disorientation, and inability to see images that results from focus/fixation disparity is one of the reasons why virtual reality has not gained wide acceptance in the marketplace.

Past attempts at matching the focus and fixation distance in virtual head mounted displays have mostly involved complicated servo mechanisms and eye trackers to change the apparent distance to the screen to match that of the point in the scene that the observer is viewing at any given time. Such devices encounter obvious problems with lag. This proposed project seeks to investigate a novel, much less complicated way of creating images in which the focus and fixation distances are matched for objects from close in to infinity seen in a head mounted stereoscopic display without using eye tracking, measuring equipment, moving parts, or feedback loops of any kind.

The principle of operation behind the proposed device is to create several divergent ray bundles for each displayed point in the scene in such a way that the complete set of bundles from each point covers the entire exit pupil of the system, and furthermore each bundle is small enough so that several go through the eye's pupil at any given time; furthermore these bundles will be created in such a way that they diverge from an intersection point at the same virtual distance at which that point is supposed to be located. The eye will then focus at the point where the bundles converge, not at the apparent display distance. The creation of these multiple bundles is accomplished by means of the very fast address and refresh rates inherent in miniature ferroelectric LCDs, in combination with a conventional collimating eyepiece and a special illumination system. The speed inherent in the display allows one to create many dozens of representations of the scene within the 1/60th second normally devoted to one. In each representation, the perspective of the scene changes slightly to create displacement of individual points within the scene. The displacement varies linearly with (virtual) distance. Over the course of creating many perspective views, a collection of beams is created which converge on each represented point in the scene. This is accomplished automatically through the rapid display of images in combination with a multiple light source illumination system that changes the direction of the light entering and exiting the system as the different images are formed. The beams collectively cover the exit pupil of the system, which can be large enough to accommodate the natural movements of the eye's pupil as the observer looks at different areas in the scene.

The proposed system accomplishes this by incorporating the design principles of an autostereoscopic display. An autostereoscopic display device is usually designed to display several different perspective views of a scene on an image-generating device, such as an LCD, and make those different perspective views of a scene visible from different regions of a plane in front of the display. Optics and/or highly directional illumination are used to make the different scenes visible in different regions of space. These “different regions of space” are usually thin high rectangles situated in a plane at a comfortable viewing distance from the display. The rectangles are narrow enough so that an observer, when situated near the viewing zone plane, always has one eye in one zone and the other eye in another zone. The observer will thus always see one image on the display with one eye and another image with the other eye. Autostereoscopic displays of this type are typically used in desktop applications. The plane where the different perspective views are visible is typically positioned at 60 cm to 80 cm from the display, that being a typical viewing distance range. The viewing zones are usually made to be 63 mm wide, or some integer fraction thereof, 63 mm being the average interpupillary distance of a pair of adult human eyes.

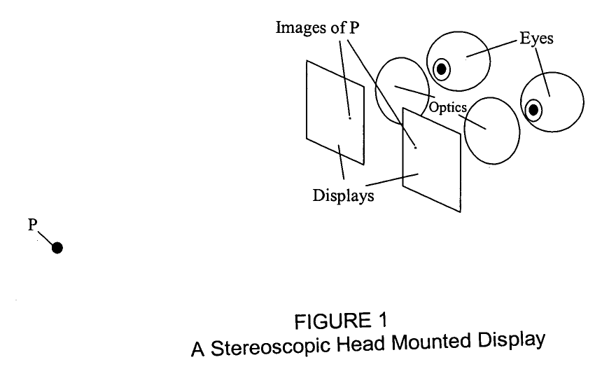

The operation of a typical stereoscopic head mounted display is illustrated in FIG. 1. Two displays are placed one in front of each eye, behind viewing optics. The viewing optics magnify the displays and place their images at some comfortable viewing distance, usually at infinity, but sometimes closer for close in work. Sometimes the viewing distance will be adjustable. For the sake of discussion, a head mounted display system that forms the images at infinity will be considered.

If a true 3D representation is desired, the two displays generate the left and right images of a stereoscopic pair. They do this by displaying two perspective views of the virtual scene that are rendered from two eye points separated by the same distance that a pair of human eyes would be when scaled correctly in the virtual scene. As a simple example, consider a point P represented in the scene. To make this point appear that it is at distance D from the observer, its image on the left eye screen is displaced slightly to the right, and its image on the right eye screen is displaced slightly to the left. In order to look at the point, the user's eyes must pivot to aim their two gaze points at the two images on the screen. When they do this, the eyes will be pointed (converged) at the virtual point P at distance D and the two points will be perceived as a single point at distance D.

Note, however, that the eyes are not focused at distance D, but rather are focused at infinity, the distance at which each of the screen images are formed. This can cause problems in two ways. First of all, it is unnatural. When looking at objects in the real world, one's eyes almost always focus and converge at the same point. If the mismatch between the two is too great in a stereoscopic display, the user may experience eyestrain and disorientation and/or will have trouble fusing the two stereo pair images into one. Secondly, if the system is being used in a mode where information on the displays is being superimposed on the real world, then there will be a focus mismatch between the virtual information and real world objects everywhere except in a single plane. The first problem is avoided in stereoscopic and autostereoscopic desktop displays simply by making sure that objects are never displayed too far or away from the screen. Most of the time this is easily accomplished since the object of interest is usually smaller than the screen itself. With a head mounted VR display, however, one is often dealing with image information that is represented as being anywhere from tens of centimeters in front of the eyes (for objects being manipulated by virtual hands, for example) to infinity (for the surrounding environment). Furthermore, there is great interest in using head mounted systems to superimpose information on the real world for training and other purposes.

Various methods have been proposed to eliminate the focus/fixation disparity in both head mounted and autostereoscopic desktop displays, but all have proved to be either unworkable or impractical. Continuous automatic adjustment of system focus has required eye-tracking systems combined with optics adjustment via servomechanisms plus perspective adjustment via software, with resultant complexity and lag problems. Dimension Technologies, Inc. and others have proposed the use of miniature volumetric displays in front of each eye. Such displays would involve the use of moving parts in the form of vibrating or spinning optics to make a display seem to vibrate back and forth through the virtual volume. To work well such a volumetric system would have to generate hundreds of images every 1/60th second, to create a 3D image built up of individual flat slices. In the desktop display world, little work has been done on this problem. One company, Visualabs, once claimed to have a 3D display that worked by varying the focus point for each pixel, but their technology turned out to be inoperable. A notable paper study was done by Nobuaki Yanagisawa and colleagues at Tokyo University (Japan) involving a lenticular lens based autostereoscopic display that focused ray bundles from many pixels into spots of light in front of the display, forming real images made up of the spots. Unfortunately, the concept was considered impractical for any display in the foreseeable future—the resolution required to form a standard NTSC (720 ×480) image of this type was estimated to be at least 10,000×8,000. Also, there was some question as to the effectiveness of the system since it would be designed to produce parallax only in the horizontal direction, not the vertical. This would tend to produce astigmatism when the person attempted to focus at the convergence points of the ray bundles, but the conditions under which this would or would not be noticeable were not investigated.

However, in the case of a head mounted systems, where the position of each eye is constrained to a small area directly in front of a display, it is possible to adapt other autostereoscopic display techniques, using microdisplays with conventional resolution but very fast refresh speeds, to direct a sufficient number of divergent ray bundles into the pupil of each eye to form images with as much resolution as the microdisplay itself, where the focal distance of each point on the image corresponds to its actual distance in virtual space. Furthermore, if two such displays are used, one in front of each eye, with each image having the proper perspective to create a stereo pair, then the convergence point of the two eyes when looking at any point on the screen will be coincident with the focus point. This should allow easy viewing of 3D objects throughout the user's normal focus range, from inches in front of the eyes all the way out to infinity.

Theory of Operation

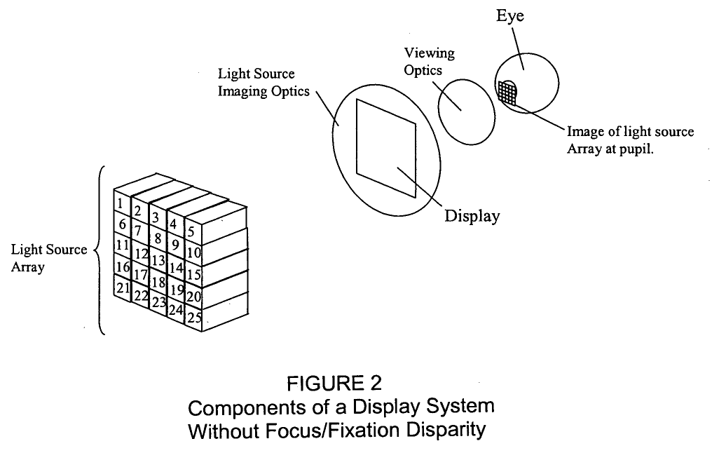

The operation of the system is illustrated in FIG. 2, which is in part based on a type of autostereoscopic display devised by Dimension Technologies, Inc. in the early 1990s (see U.S. Pat. No. 5,311,220 herein incorporated as a reference). An array of many small light sources such as LEDs, ideally square in shape and arranged in a rectangular pattern with m columns and n rows, illuminates an LCD display. The array light sources within the array are made to flash on and off in succession, one after the other in some order, for example a raster scan order in which first the lamp in position 1 turns on and off, then the lamp in position 2, etc. on down to the lamp in position 25, after which the process repeats. Ideally, the entire sequence during which each lamp in the array turns on and off should occur within 1/60^{th} second.

A lens positioned near the LCD, in combination with the viewing optics, focuses the light from each lamp into a small square area in front of the viewing optics, where an image of the array is formed in a plane. This plane is ideally coincident with the tangent plane at the front of the eye as it looks at the display through the viewing optics. Ideally, the size of the lamp array and the optical properties of the lenses will create an image of the array such that there are several focused squares of light within or directly in front of the pupil area of the eye. The viewing optics will also magnify the display and make it look like it is situated at some distance, typically at infinity, from the observer.

As the different light sources flash on and off the LCD, in turn, generates a series of 3D perspective images of the virtual scene that is being created. Each perspective image is a view of the scene as rendered using an eye point that is coincident with the center of the square area where light is being focused when that image is displayed. Thus, each rendering of the scene has a slightly different perspective, and objects within it are shifted slightly relative to one another in the horizontal and vertical directions as different lamps flash on and off.

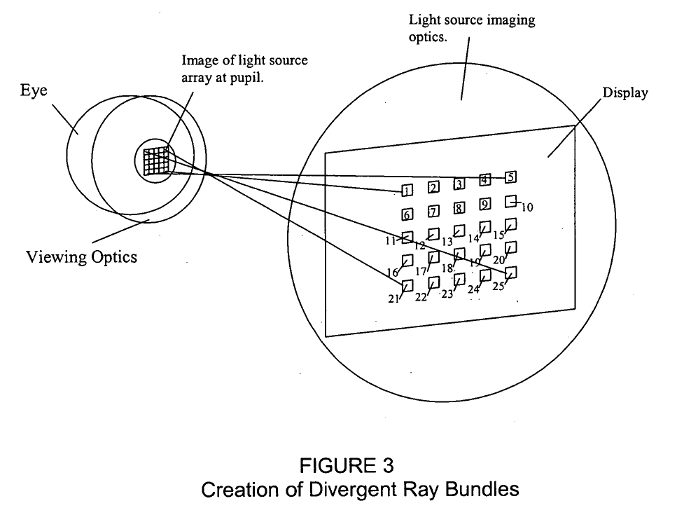

The method by which this process creates divergent ray bundles from each point on the image is illustrated in FIG. 3. FIG. 3, a close up of the area near the eye, shows what happens when the system tries to represent a single point that is located between the display and the viewing optics. For simplicity, the viewing optics are assumed to be a simple lens set up directly in front of the eye at one focal length from the display. The light sources are outside the picture to the right in this close up view. Twenty-five bundles of light that are shown coming out of the display through 25 pixels, labeled 1-25 that are turned on in sequence (become transparent) as each of the light sources 1-25 turn on in sequence. Since only one point is being represented, only one pixel is on at any time. Each ray bundle proceeds from its pixel on the display to the image of the light source located at the pupil of the eye. As the different light sources flash on and off, a complete image of the array is built up on the pupil. Furthermore, because of the positions of each “on” pixel and its corresponding light source, all the ray bundles cross at a point P′ between the display and the eye.

In most situations, of course, one will be trying to represent more than a single point. Therefore, in most situations, a complete perspective view of a scene will be displayed on the screen as each light flashes. As the individual perspective views are displayed on the screen, a collection of 25 light bundles is created for each individual point in the scene. Each set of bundles converges to a different position.

The number of focused squares that are needed to cover the area that each pupil can occupy during the course of normal eye movement is not large. In a good head mounted system, the head is not allowed to move relative to the displays. Therefore the only area that one has to be concerned with is the rather limited area where the pupils can move as the observer looks at different areas of the image. The normal goal that head mounted system designers strive for to accommodate this pupil movement is 10 mm, although sizes less than this are often acceptable, and in some cases wider areas are desired. Covering a 10 mm×10 mm circle with viewing zones 1 mm on a side would require about 80 zones. The pupil itself, being smaller than 10 mm, would accept a certain fraction of these zones at any given time. The size of a typical pupil for a young adult ranges from 2.5 mm in bright light to 7 mm in dim light. An average value halfway between these two extremes would be 4.75 mm. Generating images for all these zones within 1/60^{th} second is actually within the range of certain currently available miniature Integrated Circuit ferroelectric LCDs (ICFLCDs), which with the right drivers would be capable of generating over 5000 images per second before the limits of pixel response and address speeds are reached. Off the shelf devices exist which are configured to generate 1728 images per second. It would be possible to cover the 10 mm diameter circle with 1.8 mm wide viewing zones every 1/60^{th} second even at these slower speeds, allowing light from in excess of five images to get into a 4.75 mm diameter pupil at any position. At the fastest possible speeds one could theoretically generate 79, 1 mm square zones, allowing light from more than 17 images to get into the pupil. Under certain limitations it is also be possible to only generate perspective in the horizontal direction without producing excessive astigmatism, thus further reducing the number of zones required and/or increasing the pupil movement range.

The One Dimensional Convergence Case

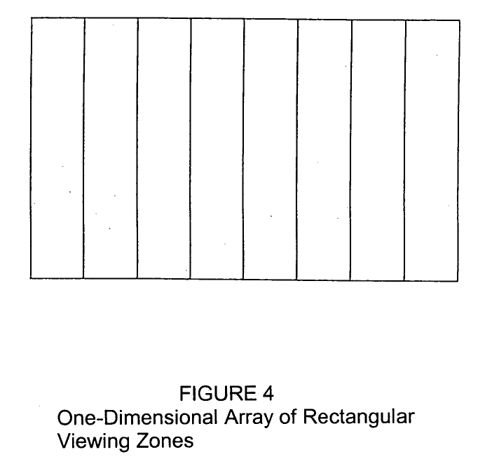

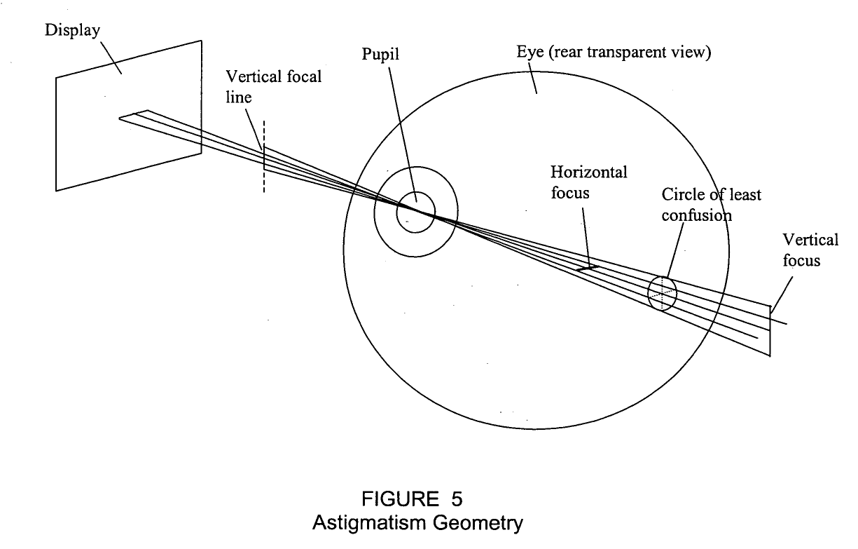

If one could get by with converging the light bundles only in one direction, one would have to use far fewer viewing zones, and the speed requirements for the microdisplay would be drastically reduced. This would open a wider variety of off the shelf microdisplays as options for use with this technique. For the one-dimensional case, a series of adjacent thin rectangular viewing zones would be created, as shown in FIG. 4. Note that now only 10, 1 mm wide zones would cover the 10 mm wide pupil area. Looking at it another way, given a fast microdisplay with a certain maximum refresh speed, one might create more and thinner zones, or use more zones to cover a wider pupil movement area. This would, of course, introduce astigmatism to the system since light is converged only in one direction. If the eye focused on the convergence point, it would perceive a short vertical line segment, instead of a point, at the focus distance. The length of this line would be dependent on the distance between the screen image and the focus point, and the size of the pupil. The geometry is illustrated with the simple model of FIG. 5.

The ray bundles are now converged in long vertical lines, not points; furthermore they diverge from the line in the horizontal direction but not in the vertical. This means that as the eye tries to focus on the line, it will focus the light as if astigmatism were present in the lens—a line of vertical focus will occur in front of the line of horizontal focus. Between the two lines a minimal blur circle, called the circle of least confusion, will occur.

In the case of people with natural uncorrected astigmatism, the tendency of the visual system is to focus in such a way that the circle of least confusion is imaged on the retina.

Presumably, the same will be true when viewing a system of the type proposed. The size of these circles will tend to limit resolution. However, this effect can be minimized if the viewing optics are designed to image the display at a distance less than infinity, ideally at a distance central to the volume that would be viewed by the device.

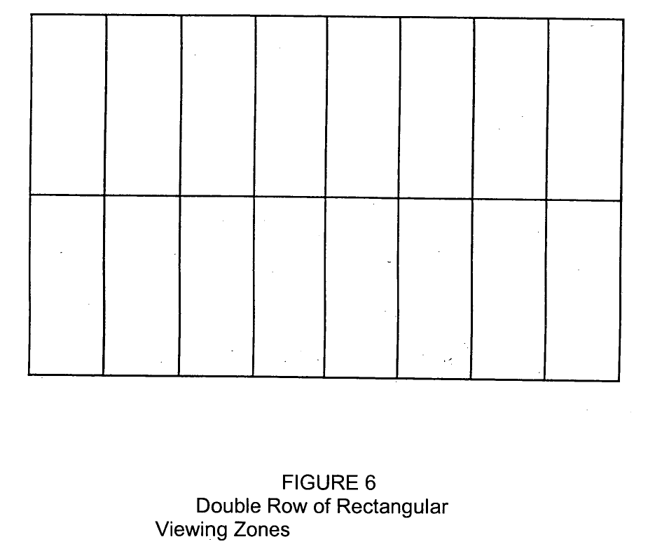

Of course, compromises in the number of zones generated in the vertical and horizontal direction may also be possible. For example one might use two or more rows of rectangular zones as shown in FIG. 6. This would reduce the astigmatism while still retaining some of the advantages accrued from using fewer zones.

Experiment have shown that it is not necessary to fill the pupil with ray bundles in order for the technique to work. If every other ray bundle were missing in FIG. 3, so that the bundles formed a checkerboard pattern, about a dozen would still get into the pupil, and half the number of perspective views would have to be generated. Once again this would allow zones to cover a wider area or the use of a slower microdisplay to cover the same area.

Experiments have shown that square or rectangular zones 1 mm wide are sufficient to achieve the desired effect in terms of creating images that they eye must focus at different distances in order to see. Experiments have also shown that there is an optimal size for the viewing zones. It is generally not desirable for light to fill the entire area of the square in FIGS. 2 and 3 or the rectangles in FIGS. 5 and 6. Sharper images will be obtained if light is concentrated in a smaller area at the center of these squares or rectangles. However, the spots must not be too small or else the image will be degraded due to diffraction effects that will become visible at the edges of objects within the scene. Experiments indicate that a spot size of 0.2-0.3 mm diameter provide the best results in terms of image clarity. It should be noted that patterns other than square or rectangular can be used. For example, a pattern of tiled hexagons or smaller spots placed at the centers of such hexagons could be used. In the case of smaller spots, the pots themselves could have any shape such as circles, squares, rectangles, triangles, and so on.

While the invention has been described in connection with a number of presently preferred embodiments thereof, those skilled in the art will recognize that many modifications and changes may be made therein without departing from the true spirit and scope of the invention which accordingly is intended to be defined solely by the appended claims

1. A display for reducing the undesirable effects of the divergence of accommodation and convergence comprising:
a multiple perspective autostereoscopic display; and
a controller for receiving image inputs from a source and connected to the autostereoscopic display and together with the multiple perspective autostereoscopic display, forming a plurality of viewing zones associated with different perspectives, each of the viewing zones being smaller than the pupil of a user, and at least two of the viewing zones being coincident with a pupil of an eye of an observer without the pupil moving.

2. The display of claim 1 in which the at least two viewing zones are formed sequentially.

3. The display of claim 1 in which the at least two viewing zones are formed simultaneously.

4. The display of claim 1 comprising viewing optics disposed between the display and the eye of an observer.

5. The display of claim 1 in which the multiple perspective autostereoscopic display includes viewing zone forming optics.

6. The display of claim 1 comprising a head mounted display.
